(19) United States
(12) Patent Application Publication
(10) Pub. No.: US 2011/0151238 A1
(43) Pub. Date: Jun. 23, 2011

(54) LOW-FRICTION COATING SYSTEM AND METHOD

(75) Inventors: Michael L. Holly, St. Clair Shores, MI (US); Sumie S. Thaker, Rochester Hills, MI (US); Brian K. Bartnick, Ortonville, MI (US); Casimir S. Jaworowicz, China, MI (US); Robert G. Sutherlin, Canton, MI (US); Douglas N. Reed, Milford, MI (US)

(73) Assignee: GM GLOBAL TECHNOLOGY OPERATIONS, INC., Detroit, MI (US)

(21) Appl. No.: 12/640,717

(22) Filed: Dec. 17, 2009

(51) Int. Cl. B32B 5/14; B05D 3/00

(52) U.S. Cl. 428/308.4; 427/247

(57) ABSTRACT

A method of forming a low-friction coating on a metal substrate includes ferritic nitrocarburizing the metal substrate to form a surface of the metal substrate, wherein the surface includes a compound zone and a diffusion zone disposed subjacent to the compound zone. After ferritic nitrocarburizing, the method includes oxidizing the compound zone to form a porous portion defining a plurality of pores, and, after oxidizing, coating the porous portion with polytetrafluoroethylene. The method further includes, after coating, curing the polytetrafluoroethylene to thereby form the low-friction coating. A low-friction coating system includes the metal substrate having the surface including the compound zone and the diffusion zone disposed subjacent said compound zone, wherein said compound zone includes the porous portion defining the pores, and a cured film formed from polytetrafluoroethylene disposed sufficiently on the porous portion so as to at least partially fill at least one of the plurality of pores.

### TECHNICAL FIELD

The present invention generally relates to a low-friction coating system and a method of forming a low-friction coating on a metal substrate.

### BACKGROUND OF THE INVENTION

Vehicle systems often include rotatable components. For example, a vehicle steering system may include a wheel bearing rotatable with respect to a constant velocity (CV) joint, and/or a rotor rotatable with respect to a wheel. Such components may be joined by a washer, e.g., a torque washer, to distribute a load between the two components and/or to prevent one component from spinning freely.

Rotation of the components with respect to each other generates friction and heat, and therefore may also produce audible noise, and/or induce wear and corrosion on mating surfaces of the components.

### SUMMARY OF THE INVENTION

A method of forming a low-friction coating on a metal substrate includes ferritic nitrocarburizing the metal substrate to form a surface of the metal substrate, wherein the surface includes a compound zone and a diffusion zone disposed subjacent to the compound zone. After ferritic nitrocarburizing, the method includes oxidizing the compound zone to form a porous portion defining a plurality of pores, and, after oxidizing, coating the porous portion with polytetrafluoroethylene. Further, the method includes curing the polytetrafluoroethylene to thereby form the low-friction coating.

A low-friction coating system includes the metal substrate having the surface including the compound zone and the diffusion zone disposed subjacent the compound zone, wherein the compound zone includes the porous portion defining the plurality of pores. The low-friction coating system also includes a cured film formed from polytetrafluoroethylene disposed sufficiently on the porous portion so as to at least partially fill at least one of the plurality of pores.

In one variation, the low-friction coating system is configured for minimizing audible noise from friction during component rotation. The low-friction coating system includes a first component and a second component. The second component is disposed in contact with the first component, and is rotatable with respect to the first component. The low-friction coating system further includes a torque washer disposed in contact with each of the first component and the second component. The torque washer has the surface including the compound zone and the diffusion zone disposed subjacent to the compound zone, wherein the compound zone includes the porous portion defining the plurality of pores. The low-friction coating system also includes the cured film formed from polytetrafluoroethylene disposed sufficiently on the porous portion so as to at least partially fill at least one of the plurality of pores. The torque washer minimizes audible noise from friction during rotation of the second component with respect to the first component.

The methods and systems minimize audible noise between two components during component rotation. In particular, the methods and systems minimize a stick slip condition between rotatable components. Further, the torque washer of the low-friction coating system exhibits a low coefficient of friction, excellent strength, stiffness, and corrosion-, wear-, and heat-resistance. Additionally, the torque washer maintains excellent clamp load between components during component rotation while simultaneously exhibiting excellent wear-resistance and a low coefficient of friction. Moreover, the methods and systems are cost-effective.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of a low-friction coating system including a metal substrate configured as a torque washer;

FIG. 1A is a magnified schematic cross-sectional view of the low-friction coating system of FIG. 1 along section line 1A including a surface having a compound zone and a diffusion zone disposed subjacent to the compound zone, wherein the compound zone includes a porous portion defining a plurality of pores; and

FIG. 2 is a schematic cross-sectional view of another variation of the low-friction coating system of FIG. 1, including the torque washer disposed in contact with each of a wheel bearing and a constant velocity joint of a vehicle.

### DESCRIPTION OF THE PREFERRED EMBODIMENTS

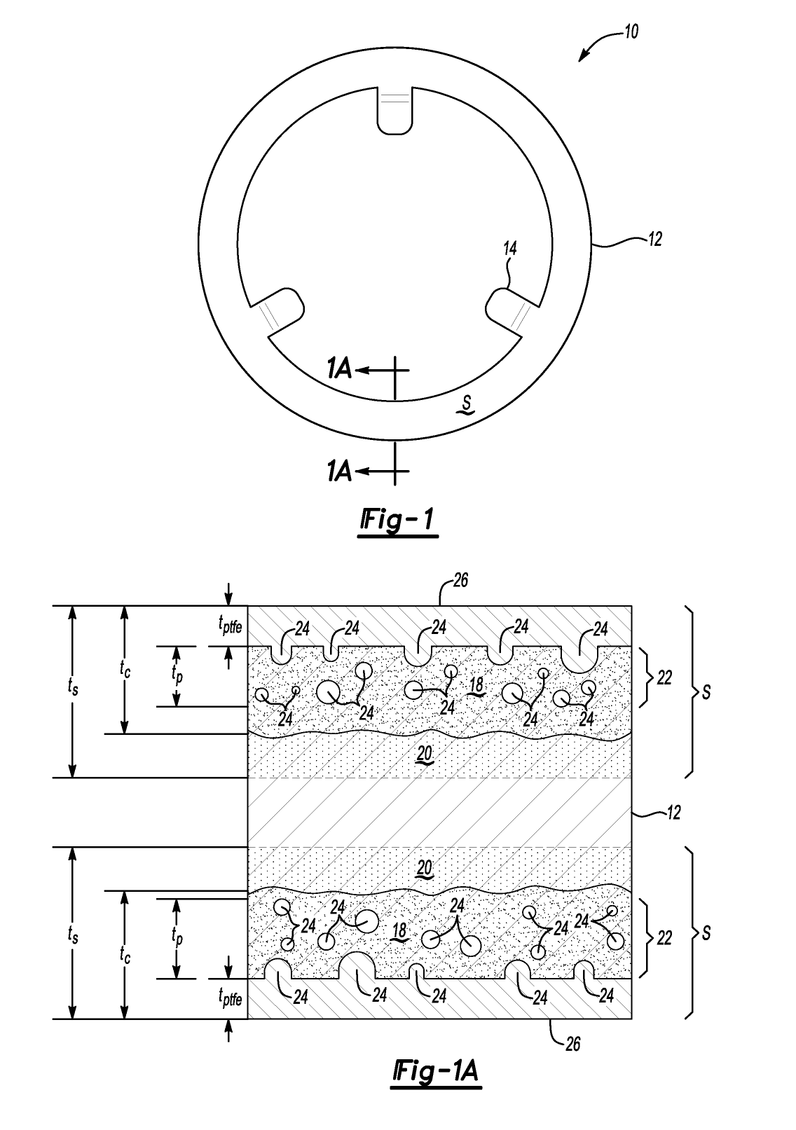

Referring to the Figures, wherein like reference numerals refer to like elements, a method of forming a low-friction coating on a metal substrate is disclosed herein. The method may be useful for forming a low-friction coating system, shown generally at 10 in FIG. 1. The method and low-friction coating system 10 may minimize friction and audible noise between rotating components, as set forth in more detail below. As such, the method and low-friction coating system 10 may be useful for automotive applications such as steering and transmission systems. However, the method and low-friction coating system 10 may also be useful for non-automotive applications such as, but not limited to, rotary pumps and turbines.

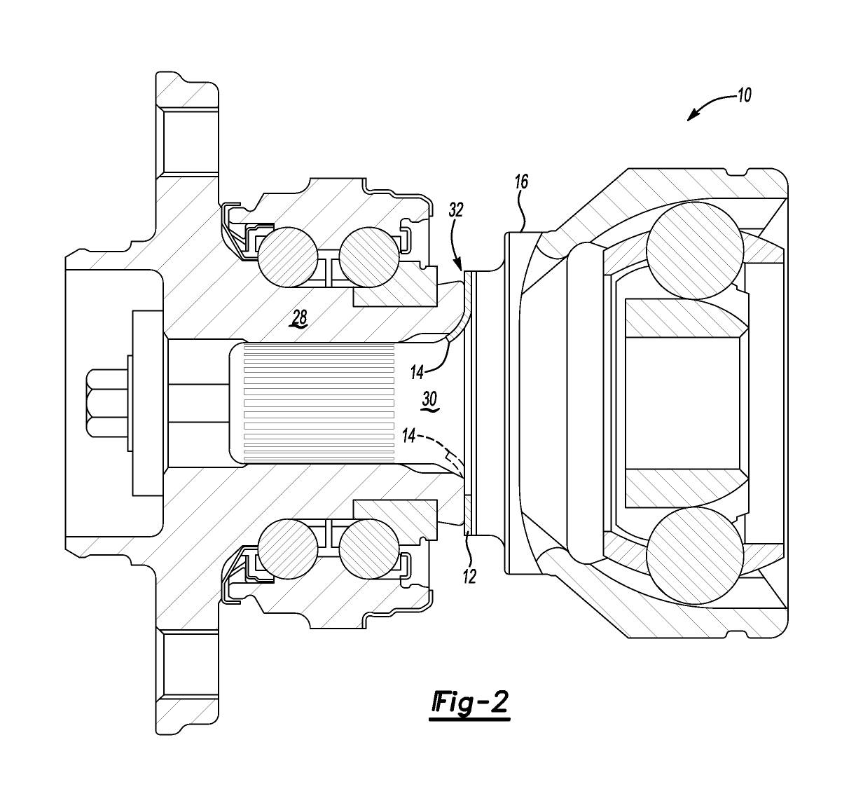

Referring to FIG. 1, the low-friction coating system 10 includes the metal substrate 12. The metal substrate 12 may be ferrous, and may be, for example, carbon steel, alloy steel, stainless steel, tool steel, cast iron, and combinations thereof. In one variation, the metal substrate 12 may be configured as a torque washer. The torque washer 12 may be formed via any suitable method such as, but not limited to, casting, machining, hot rolling sheet steel, cold rolling sheet steel, cold rolling bar stock, cold stamping, hot forming, press forming, screw machine processing, and the like. The resulting torque washer 12 may have any suitable shape and may include one or more tabs 14 suitable for retaining the torque washer 12 against a first component 16 (FIG. 2), as set forth in more detail below. For example, the tabs 14 may engage the torque washer 12 against the first component 16 (FIG. 2) to minimize unseating.

Referring to FIG. 1A, the metal substrate 12 has a surface shown generally at S that may have a thickness tₛ of from about 3 to about 25 micrometers, e.g., from about 10 to about 20 micrometers. Referring again to FIG. 1, it is to be appreciated that the surface S generally refers to an external, outer boundary of the metal substrate 12. Therefore, the torque washer 12 may have, for example, at least a top and bottom surface S.

Referring again to FIG. 1A, the surface S includes a compound zone 18, i.e., a white layer. The compound zone 18 is an outer portion of the surface S and generally provides the metal substrate 12 with excellent wear- and corrosion-resistance. In particular, the compound zone 18 may include an epsilon carbonitride phase, e.g., Fe₃N, gamma prime nitrides Fe₄N, cementite Fe₃C, and alloy carbides and nitrides. The compound zone 18 may be formed via ferritic nitrocarburizing, as set forth in more detail below.

Referring to FIG. 1A, the surface S also includes a diffusion zone 20 disposed subjacent to the compound zone 18. That is, the diffusion zone 20 is disposed beneath the compound zone 18 and is comparatively closer to a central core of the metal substrate 12 than the compound zone 18. The diffusion zone 20 generally provides the metal substrate 12 with excellent fatigue strength, and may also be formed via ferritic nitrocarburizing, as set forth in more detail below.

Referring to FIG. 1A, the compound zone 18 includes a porous portion 22 defining a plurality of pores 24. The porous portion 22 may be spaced apart from the diffusion zone 20. That is, the porous portion 22 may be disposed at an outermost region of the compound zone, i.e., farthest away from the central core of the metal substrate 12, and provides a receptor region for an additional coating layer. That is, the plurality of pores 24 provide voids that may be filled with the additional coating layer. Each pore 24 may have any size and/or shape, and may have the same or different size and/or shape from any other pore 24. The porous portion 22 may have a thickness tₚ of from about 10% to about 50% of a thickness t_{c} of the compound zone 18. The porous portion 22 may be formed via oxidizing the compound zone 18, as set forth in more detail below.

Referring again to FIG. 1A, the low-friction coating system 10 also includes a cured film 26 formed from polytetrafluoroethylene disposed sufficiently on the porous portion 22 so as to at least partially fill at least one of the plurality of pores 24. That is, one or more pores 24 of the porous portion 22 along an external edge of the surface S of the metal substrate 12 may act as a receptor site for the cured film 26 formed from polytetrafluoroethylene. Therefore, the porous portion 22 thereby promotes adhesion of the cured film 26 to the compound zone 18. The cured film 26 formed from polytetrafluoroethylene may have a dry film thickness t_{ptfe} of from about 15 to about 20 micrometers, e.g., about 15 micrometers. The presence of the porous portion 22 provides excellent adhesion between the compound zone 18 and the cured polytetrafluoroethylene film 26. And, accordingly, the cured film 26 formed from polytetrafluoroethylene provides the metal substrate 12 of the low-friction coating system 10 with excellent slipperiness. Suitable polytetrafluoroethylene is commercially available from Whitford Corporation of Elverson, Pa., under the trade name Xylan® 1014.

Referring now to FIG. 2, in one variation, the low-friction coating system 10 is configured for minimizing audible noise from friction during component rotation. In this variation, the low-friction coating system 10 includes a first component 16 and a second component 28 disposed in contact with the first component 16 and rotatable with respect to the first component 16. For example, for automotive applications, the first component 16 may be a constant velocity (CV) joint including a splined half shaft 30, and the second component 28 may be a wheel bearing configured to rotate with respect to the CV joint. That is, as shown in FIG. 2, the wheel bearing may be an assembly including a combination of a housing, ball bearings, a sleeve, and/or a bolt for inducing clamp load. The wheel bearing may be connected to the CV joint via the splined half shaft 30, and may rotate with respect to the CV joint. Similarly, although not shown, the first component 16 may be a rotor and the second component 28 may be a wheel configured for rotation with respect to a rotor.

Referring again to FIG. 2, in this variation, the low-friction coating system 10 further includes the torque washer 12 disposed in contact with each of the first component 16 and the second component 28. That is, the torque washer 12 may be disposed at an interface 32 between the CV joint, i.e., the first component 16, and the wheel bearing, i.e., the second component 28. As set forth above, and with reference to FIG. 1A, the torque washer 12 has the surface S including the compound zone 18 and the diffusion zone 20 disposed subjacent to the compound zone 18. And, the compound zone 18 includes the porous portion 22 defining the plurality of pores 24.

The torque washer 12 may have a coefficient of friction of about 0.09 when disposed in contact with the first component. Therefore, because of the low-friction coating, i.e., the cured film 26 (FIG. 1A) formed from polytetrafluoroethylene disposed on the porous portion 22 (FIG. 1A) of the compound zone 18 (FIG. 1A), the torque washer 12 exhibits excellent slipperiness with respect to the first component 16. Therefore, the torque washer 12 minimizes audible noise from friction during rotation of the second component 28 with respect to the first component 16. Since wheel bearings and CV joints can rotate while a vehicle is in motion, friction between the components 16, 28 can create a stick slip condition, i.e., a condition in which frictional energy causes the rotating components 16, 28 to first stick, then slip. The stick slip condition may produce a resulting audible noise, e.g., a click. The torque washer 12 including the cured film 26 formed from polytetrafluoroethylene disposed on the porous portion 22 minimizes the clicking sound.

Additionally, the torque washer 12 of the low-friction coating system 10 maintains excellent clamp load between the first component 16 and second component 28 during rotation, while exhibiting excellent wear-resistance, as provided by the diffusion zone 20, and a low coefficient of friction, as provided by the cured film 26 formed from polytetrafluoroethylene disposed on the porous portion 22 of the compound zone 18. That is, the excellent wear-resistance and low coefficient of friction of the torque washer 12 minimize fretting wear on surfaces of the rotating components 16, 28. Since clamp load may deteriorate as surfaces wear, the torque washer 12 therefore provides excellent clamp load for joints. Excellent clamp load is particularly important for applications including the wheel bearing and CV joint since consistent clamp load maintains excellent wheel bearing performance, e.g., sealing and stiffness.

The method of forming the low-friction coating on the metal substrate 12 is described with general reference to FIGS. 1 and 1A. The method includes ferritic nitrocarburizing the metal substrate 12 to form the surface S of the metal substrate 12, wherein the surface S includes the compound zone 18 and the diffusion zone 20 disposed subjacent to the compound zone 18, as set forth above. Ferritic carburizing diffuses nitrogen and carbon into the metal substrate 12. That is, ferritic nitrocarburizing is a thermochemical diffusion process that introduces nitrogen and carbon into the metal substrate 12 to form the compound zone 18 and the diffusion zone 20. More specifically, as set forth in more detail below, ferritic nitrocarburizing entraps diffused nitrogen and carbon atoms in interstitial lattice spaces (not shown) of the metal substrate 12.

The metal substrate 12 may be ferritic nitrocarburized by any suitable method, e.g., solid-, liquid-, and/or gaseous-ferritic nitrocarburizing. Ferritic nitrocarburizing produces the surface S, which may be known as a case hardened surface S, including the compound zone 18 and the diffusion zone 20.

More specifically, gaseous ferritic nitrocarburizing may expose the metal substrate 12 to a nitrogen-containing gas, e.g., ammonia, and a carbon-containing gas, e.g., a hydrocarbon gas such as methane or propane, at a temperature of from about 550° C. to about 590° C. For example, the metal substrate 12 may be exposed to a blended gas including ammonia, methane, and oxygen at a temperature of about 570° C. Exposure to the blended gas may induce cracked nascent ammonia gas to dissociate at the surface S of the metal substrate 12 and react with the hydrocarbon gas according to the following reactions.

In particular, ammonia dissociates on the surface S of the metal substrate 12 according to reaction (1).

NH₃→N+3/2H₂ (1)

And, carbon dioxide is generated according to the water-gas reaction (2).

CO₂+H₂ [symbol] H₂+CO (2)

Further, when the metal substrate 12 is exposed to a gaseous atmosphere including ammonia and an endothermic gas mixture including carbon monoxide, a dominant carburizing reaction (3) occurs at a temperature of about 570° C. As used herein, carburizing refers to diffusion of carbon into the surface S of the metal substrate 12.

CO+H₂ [symbol] C+H₂O (3)

In particular, carburizing occurs according to a relationship expressed by equation (4).

$${a}_{c} {K}_{3} \frac{ρ CO \cdot ρ {H}_{2}}{ρ {H}_{2} O} \qquad ( 4 )$$

wherein

a_{c}=carbon activity,

K₃=equilibrium constant,

ρCO=partial pressure of carbon monoxide,

ρH₂=partial pressure of hydrogen,

ρH₂O=partial pressure of water vapor.

Likewise, nitriding activity occurs according to a relationship expressed by equation (5). As used herein, nitriding refers to introduction of nitrogen into the surface S of the metal substrate 12.

$${a}_{N}^{′} = {K}_{1} \frac{ρ {NH}_{3}}{ρ {H}_{2}^{3 / 2}} \qquad ( 5 )$$

wherein

a′_{N}=nitriding activity,

K₁=equilibrium constant,

ρNH₃=partial pressure of ammonium,

ρH₂^{3/2}=partial pressure of hydrogen.

Ammonia addition at constant pressure to the gaseous atmosphere surrounding the metal substrate 12 results in a drop in the partial pressure of hydrogen and an increase in the nitriding activity according to a relationship expressed by reaction (6).

NH₃+CO [symbol] HCN+H₂O (6)

And, hydrogen cyanide present in the gaseous atmosphere as a result of ammonia interaction with carbon monoxide supplies nitrogen in parallel to nitrogen present according to dissociation reaction (1). Therefore, mass transfer of nitrogen to the compound zone 18, i.e., build-up of nitrogen in the compound zone 18, occurs according to reaction (7), and nitriding activity of the compound zone 18 occurs according to equation (8).

HCN→C+N+½H₂ (7)

$${a}_{N}^{′} = {K}_{2} \frac{ρ HC N}{{a}_{c} ρ {H}_{2}^{1 / 2}} \qquad ( 8 )$$

wherein

a′_{N}=nitriding activity,

K₂=equilibrium constant,

ρHCN=partial pressure of hydrogen cyanide,

a_{c}=carbon activity,

ρH₂^{1/2}=partial pressure of hydrogen.

In another variation of ferritic nitrocarburizing, solid ferritic nitrocarburizing may expose the metal substrate 12 to a nitrogen- and carbon-containing salt bath at a temperature of from about 550° C. to about 590° C. For example, the metal substrate 12 may be exposed to a cyanide salt bath at a temperature of about 570° C. for from about 1 to about 2 hours. Exposure to the cyanide salt bath may induce cyanate ions to react at the surface S of the metal substrate 12 according to reactions (9)-(12).

4KOCN→K₂CO₃+CO+2N* (9)

2CO→CO₂+C** (10)

KCN+CO₂→KOCN+CO (11)

2KCN+O₂→2KOCN (12)

And, nitrogen and carbon react with iron of the ferrous metal substrate 12 according to reactions (13) and (14).

*N=3Fe→Fe₃N (13)

**C+3Fe→Fe₃C (14)

Therefore, ferritic nitrocarburizing forms the surface S of the metal substrate 12 including the compound zone 18 and the diffusion zone 20.

The method may also include preparing the metal substrate 12 for ferritic nitrocarburizing. For example, the method may include descaling and/or heating the metal substrate 12 prior to ferritic nitrocarburizing. That is, the metal substrate 12 may be exposed to an acid, e.g., muriatic acid, sulfuric acid, and/or phosphoric acid, to remove scale, i.e., iron oxide, from the metal substrate 12 prior to ferritic nitrocarburizing. Likewise, the metal substrate 12 may be heated, e.g., to about 400° C. in a convection furnace. Heating the metal substrate 12 prior to ferritic nitrocarburizing minimizes moisture in the metal substrate 12, which may react with the nitrogen-containing gas, the carbon-containing gas, and/or contents of the nitrogen- and carbon-containing salt bath.

With continued reference to FIG. 1A, after ferritic nitrocarburizing, the method further includes oxidizing the compound zone 18 to form the porous portion 22 defining the plurality of pores 24. That is, oxidizing may expose the compound zone 18 to oxygen to form the porous portion 22. Oxidation may be performed by any suitable method, e.g., by controlling nitriding and carburizing potentials and/or oxygen exposure rates.

For applications including solid ferritic nitrocarburizing via the cyanide salt bath set forth above, oxidizing may expose the compound zone 18 to an oxidizing salt bath at a temperature of from about 425° C. to about 430° C. for from about 10 minutes to about 30 minutes to form the porous portion 22. For example, the metal substrate 12 may be immersed in the oxidizing salt bath at a temperature of about 427° C. for about 20 minutes.

The oxidizing salt bath may be an alkali hydroxide/nitrate mixture that oxidizes the compound zone 18 of the metal substrate 12 to form an oxide/nitride mixture in the compound zone 18. The formation of the oxide/nitride mixture provides the metal substrate 12 with excellent corrosion-resistance. As such, the oxidizing salt bath may include from about 2 parts by weight to about 20 parts by weight, e.g., from about 10 parts by weight to about 15 parts by weight, nitrate ions based on 100 parts by weight of the oxidizing salt bath. Suitable nitrate ions may include, but are not limited to, sodium nitrate, potassium nitrate, and combinations thereof. Likewise, the oxidizing salt bath may include from about 25 parts by weight to about 40 parts by weight carbonate ions based on 100 parts by weight of the oxidizing salt bath. Suitable carbonate ions may include, but are not limited to, sodium carbonate, potassium carbonate, and combinations thereof. Moreover, the oxidizing salt bath may include from about 40 to about 73 parts by weight hydroxide ions based on 100 parts by weight of the oxidizing salt bath. Suitable hydroxide ions may include, but are not limited to, sodium hydroxide, potassium hydroxide, and combinations thereof.

In particular, oxidizing may occur according to reactions (15)-(17).

CN⁻¹+3OH⁻¹+NO₃⁻¹→CO₃⁻²+NO₂⁻¹+NH₃+O⁻² (15)

CNO⁻¹+3OH⁻¹→CO₃⁻²+NH₃+O⁻² (16)

[Fe(CN)₆]⁻⁴+6NO₃⁻¹→FeO+5CO₃⁻²+5CO₃⁻²+6N₂+CO₂ (17)

Therefore, oxidizing the compound zone 18 forms the porous portion 22 defining the plurality of pores 24.

With continued reference to FIG. 1A, after oxidizing, the method further includes coating the porous portion 22 with polytetrafluoroethylene. That is, coating may at least partially fill at least one of the plurality of pores 24 with polytetrafluoroethylene. The polytetrafluoroethylene may be applied via any suitable method. For example, the polytetrafluoroethylene may be applied via a fluidized bed, or may be sprayed onto the metal substrate 12. Alternatively, the metal substrate 12 may be coated with polytetrafluoroethylene via dip-coating or roll-coating.

The method may further include pre-treating the metal substrate 12 after oxidizing and prior to coating the porous portion 22 with polytetrafluoroethylene. For example, the metal substrate 12 including the compound zone 18 and the diffusion zone 20 may be degreased in a solvent solution or a water-based caustic such as sodium hydroxide. Then, after degreasing, the metal substrate 12 may be iron- or zinc-phosphated to passivate the surface S of the metal substrate 12 and provide further improved adhesion of the cured film 26 formed from polytetrafluoroethylene to the porous portion 22.

Additionally, the method may further include cooling the metal substrate 12 after oxidizing and prior to coating the porous portion 22 with polytetrafluoroethylene. That is, the metal substrate 12 may be cooled to room temperature by air cooling and/or thermal quenching with water.

After coating, the method further includes curing the polytetrafluoroethylene to thereby form the low-friction coating, i.e., the cured film 26. The polytetrafluoroethylene may be cured at a temperature of from about 220° C. to about 345° C. for from about 5 to about 20 minutes to coat the porous portion 22 of the compound zone 18. Therefore, curing the polytetrafluoroethylene on the porous portion 22 of the compound zone 18 forms the cured film 26, i.e., the low-friction coating, on the metal substrate 12, and thereby provides the metal substrate 12 with a low coefficient of friction.

The method provides the metal substrate 12, e.g., the torque washer, with the aforementioned low coefficient of friction and excellent strength and corrosion-, wear-, and heat-resistance. The method also provides the torque washer 12 with unexpected stiffness. That is, the cured film 26 disposed on the porous portion 22 of the compound zone 18 of the torque washer 12 imparts a stiffness to the torque washer 12. As such, the tabs 14 (FIG. 1) of the torque washer 12 may function as stiff springs and be less prone to breakage during assembly, installation, maintenance, and/or operation of the torque washer 12.

The methods and systems 10 minimize audible noise between two components 16, 28 during component rotation. In particular, the methods and systems 10 minimize a stick slip condition between rotatable components 16, 28. Further, the torque washer 12 of the low-friction coating system 10 exhibits a low coefficient of friction, and excellent strength, stiffness, and corrosion-, wear-, and heat-resistance. Additionally, the torque washer 12 maintains excellent clamp load between components 16, 28 during component rotation while simultaneously exhibiting excellent wear-resistance and a low coefficient of friction. Moreover, the methods and systems 10 are cost-effective.

While the best modes for carrying out the invention have been described in detail, those familiar with the art to which this invention relates will recognize various alternative designs and embodiments for practicing the invention within the scope of the appended claims.

1. A method of forming a low-friction coating on a metal substrate, the method comprising:
ferritic nitrocarburizing the metal substrate to form a surface of the metal substrate including a compound zone and a diffusion zone disposed subjacent to the compound zone;
after ferritic nitrocarburizing, oxidizing the compound zone to form a porous portion defining a plurality of pores;
after oxidizing, coating the porous portion with polytetrafluoroethylene; and
after coating, curing the polytetrafluoroethylene to thereby form the low-friction coating.

2. The method of claim 1, wherein oxidizing exposes the compound zone to oxygen to form the porous portion.

3. The method of claim 2, wherein the porous portion is spaced apart from the diffusion zone and has a thickness of from about 10% to about 50% of a thickness of the compound zone.

4. The method of claim 2, wherein oxidizing exposes the compound zone to an oxidizing salt bath at a temperature of from about 425° C. to about 430° C. for from about 10 minutes to about 30 minutes to form the porous portion.

5. The method of claim 4, wherein the oxidizing salt bath includes from about 2 parts by weight to about 20 parts by weight nitrate ions based on 100 parts by weight of the oxidizing salt bath.

6. The method of claim 4, wherein the oxidizing salt bath includes from about 25 parts by weight to about 40 parts by weight carbonate ions based on 100 parts by weight of the oxidizing salt bath.

7. The method of claim 4, wherein the oxidizing salt bath includes from about 40 to about 73 parts by weight hydroxide ions based on 100 parts by weight of the oxidizing salt bath.

8. The method of claim 1, wherein coating at least partially fills at least one of the plurality of pores with polytetrafluoroethylene.

9. The method of claim 1, wherein ferritic nitrocarburizing diffuses nitrogen and carbon into the metal substrate.

10. The method of claim 9, wherein ferritic nitrocarburizing exposes the metal substrate to a nitrogen-containing gas and a carbon-containing gas at a temperature of from about 550° C. to about 590° C.

11. The method of claim 9, wherein ferritic nitrocarburizing exposes the metal substrate to a nitrogen- and carbon-containing salt bath at a temperature of from about 550° C. to about 590° C.

12. The method of claim 1, further including descaling the metal substrate prior to ferritic nitrocarburizing.

13. The method of claim 1, further including cooling the metal substrate after oxidizing and prior to coating.

14. The method of claim 1, further including pre-treating the metal substrate after oxidizing and prior to coating.

15. A low-friction coating system comprising:
a metal substrate having a surface including a compound zone and a diffusion zone disposed subjacent said compound zone, wherein said compound zone includes a porous portion defining a plurality of pores; and
a cured film formed from polytetrafluoroethylene disposed sufficiently on said porous portion so as to at least partially fill at least one of said plurality of pores.

16. The low-friction coating system of claim 15, wherein said porous portion is spaced apart from said diffusion zone and has a thickness of from about 10% to about 50% of a thickness of said compound zone.

17. The low-friction coating system of claim 15, wherein said metal substrate is ferrous.

18. The low-friction coating system of claim 15, wherein said metal substrate is configured as a torque washer.

19. A low-friction coating system configured for minimizing audible noise from friction during component rotation, the low-friction coating system comprising:
a first component;
a second component disposed in contact with said first component and rotatable with respect to said first component;
a torque washer disposed in contact with each of said first component and said second component and having a surface including a compound zone and a diffusion zone disposed subjacent to said compound zone, wherein said compound zone includes a porous portion defining a plurality of pores; and
a cured film formed from polytetrafluoroethylene disposed sufficiently on said porous portion so as to at least partially fill at least one of said plurality of pores;
wherein said torque washer minimizes audible noise from friction during rotation of said second component with respect to said first component.

20. The low-friction coating system of claim 19, wherein the torque washer has a coefficient of friction of about 0.09 when disposed in contact with said first component.
